(19) United States
(12) Patent Application Publication
(10) Pub. No.: US 2023/0051031 A1
(43) Pub. Date: Feb. 16, 2023

(54) MULTI-FUNCTIONAL HYBRID MATERIAL BASED ON SEPIOLITE FOR ENVIRONMENTAL RECOVERY AND BIO-REMEDIATION

(71) Applicant: CONSIGLIO NAZIONALE DELLE RICERCHE, Roma (IT)

(72) Inventors: Maria Rosaria Plutino, Roma (IT); Simone Cappello, Roma (IT)

(73) Assignee: CONSIGLIO NAZIONALE DELLE RICERCHE, Roma (IT)

(21) Appl. No.: 17/757,564

(22) PCT Filed: Dec. 15, 2020
(86) PCT No.: PCT/IB2020/061958

§ 371 Date: Jun. 17, 2022

(30) Foreign Application Priority Data
Dec. 19, 2019 (IT) 102019000024754

(51) Int. Cl. B01J 20/12; B01J 20/28; C02F 1/28; C02F 3/34

(52) U.S. Cl. CPC B01J 20/12; B01J 20/28045; C02F 1/288; C02F 3/344; C02F 2101/32

(57) ABSTRACT

A multifunctional hybrid material based on sepiolite for environmental recovery and bio-remediation is described. In particular, the invention describes the design and development of suitably functionalized hybrid nanomaterials starting from sepiolite and the subsequent study of the absorbent and degrading properties in relation to aromatic hydrocarbons, by activating hydrocarbon-clastic bacteria. These nanomaterials have been prepared in order to remove hydrocarbon pollutants (e.g. oil) in natural matrices (marine environment), with potential applications in the field of environmental remediation.

### FIELD OF THE INVENTION

The present invention relates to a multi-functional hybrid material based on sepiolite for environmental recovery and bio-remediation.

### BACKGROUND ART

Over recent decades, the problem of pollution of the water resources of our planet, in particular of the sea, which constitutes 97% of the total water reserves, has proved to be particularly urgent, since the presence of chemical substances, solid wastes, and microplastics in the marine environment is very dangerous for the survival of numerous living species and for human health.

The presence of chemical substances in the sea, such as hydrocarbons, metals, chlorinated solvents, phosphates, plastics, and microplastics can have anthropic and natural origins. In the first case, said pollutants can originate from phenomena such as the release of industrial and civil wastewater into the sea, from accidental spillages of oil due to mishaps during the transportation thereof on board large tankers, from agriculture due to the absorption by the soil and of the water table of species such as water-soluble pesticides and fertilizers. In the second case, their presence is caused, meanwhile, by atmospheric and seasonal events, such as landslides and floods. According to statistics, it has been found that only 12% of marine pollution is attributable to maritime transport, while 44% comes from the land and 33% from the air.

In more detail, marine pollution can be classified as follows:
off-shore pollution: this comprises all the pollution which occurs far away from the coast, very often caused by spillages during the washing of the tanks or by the release of bilge from large vessels, from naval accidents or accidents on drilling platforms;
shore pollution: this is the most harmful and dangerous form of pollution because it is very difficult to eradicate due to the shallow waters; the various units designated to providing pollutant recovery services, and likewise the such various devices, such as skimmers, are unable to take action, while manual removal through human intervention has proved fundamental;
underwater pollution: which usually occurs following a fire (such as, for example, that of the “Haven” oil tanker in the Gulf of Genoa), following which the light component of the hydrocarbon evaporates and the heavy component heavy precipitates, depositing on the seabed.

In the case of hydrocarbon substances, the pollution can be systematic or accidental. Nevertheless, it has been determined that only 10% of the hydrocarbons which contaminate the seas come from accidental spills. The rest come from chronic sources, such as polluting particles falling back down from the atmosphere, from natural seepage, from the washing away of the mineral oils dispersed in the environment, leaks from refineries or drilling systems on open-sea platforms and, above all, from tankers (oil and otherwise) discharging ballast water into the sea (which amounts to 20% of the total pollution). Crude oil is the oil in the state in which it is extracted from the oil fields, while the derivative materials (which are obtained by refining crude oil) include fuels and fuel oil. According to biogenic theory, oil is a non-renewable fossil fuel, composed essentially of hydrocarbons, which is derived from the decomposition of plant and animal organisms which has taken place within an anaerobic environment, following the continuous accumulation thereof in the subsoil for millions of years inside rocks which gradually form.

From a chemical viewpoint, crude oil is an emulsion of hydrocarbons and other impurities with water, typically 40% cycloalkanes, 30% alkanes, 25% aromatic hydrocarbons, and 5% other substances.

The light components represent 95% of the soluble fraction of oil and are constituted of aliphatic hydrocarbons (alkanes and cycloalkanes) containing up to 10 carbon atoms, characterized by low solubility in water (a few mg/l), and of monoaromatic hydrocarbons (benzene, toluene and xylene), with a higher solubility than the aliphatic ones. They are characterized by: (i) a maximum boiling point of 150° C.; (ii) rapid and complete evaporation, generally within a day.

The medium components are aliphatic hydrocarbons containing from 11 to 22 carbon atoms (highly biodegradable alkanes whose concentration over time is a measurement of the degradation of the spilled oil), diaromatic hydrocarbons (naphthalene) and polyaromatic hydrocarbons (phenanthrene, anthracene, etc.). They are characterized by: (i) boiling point comprised between 150 and 400° C.; (ii) low evaporation speed, which reaches several days (certain residues do not evaporate at room temperature environment); (iii) low solubility in water (a few mg/l).

Lastly, the heavy components are hydrocarbons containing 23 or more carbon atoms in addition to waxes, asphaltenes, and polar compounds. They are characterized by: (i) minimum loss through evaporation; (ii) minimum solubility; (iii) long-term persistence in sediment in the form of lumps of tar or asphalt layers. They are the most persistent compounds and are characterized by low degradation speed.

The main physical properties which influence the behaviour and the persistence of hydrocarbons in the sea are: the specific gravity (relative density), the evaporation tendency (which describes their volatility), the viscosity (which describes the creep resistance) and the pour point [i.e. the temperature below which the hydrocarbon does not pour any more and assumes a semisolid state. The value thereof essentially depends on the wax and asphaltene content thereof]. Once the physical characteristics of hydrocarbons had been considered, a classification known as the API (American Petroleum Institute) was established and accepted internationally, which subdivides the crude oils into four classes according to their density in ° API (° API=(141.5/relative density)−131.5). By combining the API classification and the empirical concept of persistence of oil in the sea, the hydrocarbons are subdivided mainly into persistent (crude oils, fuel oils, and bitumens) and non-persistent (benzine, kerosene, and diesel). On the basis of this classification, four main groups of crude oils and materials can be distinguished, as shown in the table below [http://www.seaforecast.cnr.it/sosbonifacio/index.php/I1-Progetto/inquinamento-marino-da-idrocarburi.html]:

| Group | Specific gravity | °API density | Persistence | Example |
|---|---|---|---|---|
| Group I | <0.8 | >45 | Non-persistent | Petrol, naphtha, kerosene |
| Group II | 0.8-0.85 | 35-45 | Shortly persistent | Diesel, Abu Dhabi Crude |
| Group III | 0.85-0.95 | 17.5-35 | Intermediate persistent | Arabian Light Crude |
| Group IV | >0.95 | <17.5 | Very persistent | Heavy Fuel Oil, |
| | | | | Venezuelan Crude Oils |

On the basis of this classification, one notes that the lower the density of an oil is (expressed as ° API), the more noxious the oil is for the marine ecosystem.

When floating on water, crude oil expands rapidly into an extensive slick, forming layers of different thicknesses, which the currents and the winds carry far off and split into ‘banks’, positioned parallel to the direction of the prevailing winds.

The composition of the mixture of oils spilled in the sea evolve over time depending on the chemical-physical characteristics of the hydrocarbons and of the weathering processes, i.e. of the atmospheric agents, such as for example, evaporation, dispersion, dissolution, oxidation, emulsification, spreading, biodegradation, sedimentation.

Through these processes, the composition of the mixture in the sea changes rapidly in the first one or two days following the spill due to the evaporation of the more volatile fractions, and then slows as said processes stabilise, proceeding towards a thermodynamic balance with the environmental conditions.

Some components penetrate the upper layers of the water, where they produce very harmful effects on marine organisms and are slowly oxidated biochemically through the action of bacteria, fungi, and algae. The heavier fractions roam, meanwhile, on the surface of the sea, until they form virtually unbiodegradable lumps which sink slowly down to the seabed. The time required for this degradation process varies according to the conditions of the sea, the meteorological conditions, the temperature and of the type of pollutant.

At first, the most significant processes are dispersion, evaporation, emulsification and dissolution, while biodegradation and sedimentation phenomena occur later on.

Therefore, one can understand how much interventions immediately after the accidental event or not, are crucial to minimise damage to the marine environment, above all to facilitate the recovery, where possible, of the ecosystems. From this perspective, the interventions can have three objectives: (i) recovery of the polluting substances, (ii) remediation of the sites and (iii) protection of the most sensitive areas.

Environmental Recovery Methods:

Management of the emergency following an oil spill at sea can be structured into a series of strategies designed for intervention in different operating conditions.

A first strategy consists of mechanical removal, which decreases noticeably as the motion of the waves and the wind speed increase. It is advisable, indeed, if the height of the waves does not exceed 2-3 feet (0.6-0.9 m) and if the wind speed is below 9-10 knots (parameters which can also limit the safety of staff involved during operations). Furthermore, mechanical removal is not advised when the thickness of the oil film is below one thousandth of an inch.

The use of the dispersants is a widely utilised technique which requires minimal conditions to be effective. If the wind speed and the height of the waves exceed a certain limit (wind speed above 25 knots and waves height above 10 feet or 3 metres), oil and in particular the lighter components thereof disperse naturally.

Generally, the use of dispersants is limited to films with a thickness comprised between one thousandth and one hundredth of an inch, nevertheless the most recent dispersants and new techniques for the employment thereof have extended this range also to films up to 0.1 inches thick (0.25 cm). In practice, for the recovery of the contaminated zones particular instruments or substances are utilised.

Floating barriers are among the most common containment systems and they act by surrounding the oil slick, thereby preventing it reaching sensitive zones present in the vicinity. Floating barriers require a certain amount of maintenance to be re-arranged according to the direction of the current, the intensity of the motion of the waves, the movement of the tides, etc. Physical removal of the oil from the surface of the water decreases the risk and the threat of contamination for birds and mammals.

There also exist various devices for the recovery of hydrocarbons which float on the surface of the water, commonly called skimmers. These are based on different collection principles and are built to work in different operating conditions.

The most common devices are weir skimmers. These are equipped with floats which keep the mouth (intake) of the device just below the surface of the water, so as to make the material sink, to then be conveyed, by means of pumps, into a tank. The tank will act as a decantation separator and the water, which will form layers below, may be released via a valve.

Adhesion devices are also utilised, which work, precisely, on the principle of adhesion of the hydrocarbons to oleophilic surfaces. These surfaces consist of discs, drums, brushes, or cords. The adhesive surface moves through the laminal layer between the water and oil and lifts the latter, after which it flows though wiper or wringer-like systems which remove and collect the hydrocarbons.

Nevertheless, a technique which has been emerging over recent years is based on the use of absorbents and dispersants. ‘Absorbent’ means any material, whether organic, inorganic or synthetic, which removes the oil by the absorption thereof into the solid material which acts as a sponge, or by adsorption on the external surface of the material. The dispersants reduce the surface tension of the water/oil interface, thereby promoting the disintegration of the particles of oil into ever smaller parts, impairing the subsequent re-agglomeration thereof. This way, natural degradation is facilitated through the motion of the waves in the sea or through microbiological agents.

Absorbent Materials:

The absorbent materials employed in the recovery of hydrocarbons from the sea can be classified as follows:
inert absorbent materials, which perform an absorbent action in relation to hydrocarbons and are composed of substances which are inert from a chemical and a biological viewpoint. They can be of synthetic, mineral, animal or plant origin;
non-inert absorbent materials, which perform an absorbent action in relation to hydrocarbons, but constitute non-inert substances from a chemical and a biological viewpoint. The can be of synthetic or natural origin and are insoluble in water: nevertheless, they can interact with living organisms, which is why the degree of toxicity on marine organisms must be assessed beforehand.

In Italy, the use of non-inert absorbents is governed according to the legislation set out in Annex 4 of the Italian decree dated 25 Feb. 2011, which states the “Testing methods and criteria for acceptability of the results of the tests needed to recognise suitability of non-inert absorbent materials of synthetic or natural origin”.

On the basis of the efficacy test, a material is considered acceptable, when the absorbent is able to retain at least 60% of the oil based on the weight thereof weight; on the basis of the toxicity assay, a material is considered acceptable when it does not show statistically significant toxicity effects with respect to the control.

Furthermore, in Italy, the DPN-DEC-2009-403 decree dated 31 Mar. 2009 breaks down inert absorbent materials into three categories:
absorbents of plant or animal origin (straw, cellulose fibre, cork, plant processing residues, birds' feathers);
absorbents of mineral origin (volcanic powders, perlites, vermiculite, zeolites);
absorbents of origin synthetic (polyethylene, polypropylene, polyurethane, polyester).

All the absorbents utilised, after the recovery of the oil, are disposed of by means of combustion. There are many materials being studied for their capacity to absorb oil. One of these is lignin, or ‘yolky’ wool (unwashed sheared wool), which is particularly water-repellent and capable of absorbing oils weighing up to 10 times their weight.

To address the environmental issues described above and the problems linked to the continuous development of new materials, an object of the present invention is therefore to provide a method for removing hydrocarbon pollutants (for example, oil) which is effective, has minimal impact on the marine ecosystem, and hopefully also finds potential application in the field of environmental remediation.

### SUMMARY OF THE INVENTION

Said object has been achieved by a functionalized hybrid material as stated in claim 1, as well as a process for its preparation.

In another aspect, the present invention concerns the use of said functionalized hybrid material as a substrate for absorbing and degrading hydrocarbon pollutants, by activating hydrocarbonoclastic bacteria, for environmental recovery and remediation.

In a further aspect, the present invention concerns a product for environmental remediation and recovery, comprising said functionalized hybrid material.

In an additional aspect, the present invention concerns a method for environmental remediation and recovery, by using the functionalized hybrid material and the product comprising the same.

### BRIEF DESCRIPTION OF THE FIGURES

The characteristics and advantages of the present invention will be apparent from the following detailed description, the embodiments provided as illustrative and non-limiting examples, and the annexed figures, wherein:

FIG. 1 shows SEM images of untreated cotton reported at different magnitudes and cuts, as per Example 1,

FIG. 2 shows SEM images of the cotton treated with the siliceous sol, as per Example 1,

FIG. 3 shows the EDX mapping spectrum and the percentage distribution of C, O, Al (carrier), and Si, of the cotton treated with the siliceous sol, as per Example 1,

FIG. 4 shows a comparison between the IR spectra of Sepiolite and of Sepiolite functionalized through various procedures, as per Example 1,

FIG. 5 shows the bacterial abundance (DAPI count) of the microbial population developed during the experimentation performed with natural seawater (SW), as per Example 1,

FIG. 6 shows the bacterial abundance (DAPI count) of the microbial population developed during the experiments performed with natural seawater (SW) and inorganic nutrients (IN), as per Example 1,

FIG. 7 shows the qualitative and quantitative hydrocarbon analysis (GC-FID analysis) expressed as a percentage (%) of oil present in different experiments performed with natural seawater (SW), as per Example 1,

FIG. 8 shows the qualitative and quantitative analysis of hydrocarbons (GC-FID analysis) expressed as a percentage (%) of oil present in different experiments carried out with natural seawater (SW) and inorganic nutrients (IN), as per Example 1,

FIG. 9 shows the visual analysis of the oil absorption by the various sepiolite samples as per Example 1, and

FIG. 10 shows a visual analysis of the oil absorption by the various sepiolite samples as per Example 1.

### DETAILED DESCRIPTION OF THE INVENTION

The invention therefore relates to a functionalized hybrid material comprising sepiolite functionalized with at least one alkoxysilane cross-linking agent, wherein said at least one cross-linking agent comprises an epoxy trialkoxysilane.

It has, indeed, surprisingly been found that this functionalization allows to obtain a hybrid material which is advantageously able to absorb the hydrocarbon pollutants, as will also be seen in the working examples provided below.

In preferred embodiments, said at least one cross-linking agent and said sepiolite are in a weight ratio of 5:1 to 1:5.

More preferably, said at least one cross-linking agent and said sepiolite are in a weight ratio of 2:1 to 1:2.

Sepiolite is a non-swelling, lightweight, porous clay (with a large specific surface area), whose individual particles have a needle-like shape. There are very few commercially exploited deposits in the world. Production comes mainly from the south-eastern United States (Miocene fields in Florida and Georgia), which amounted to about 1.8 million tonnes in 1989, and—to a much lesser extent—from Senegal, Spain, Australia, India, Turkey, South Africa and France. Together with palygorskite, it is referred to as a “special clay”.

The large surface area and high porosity, as well as the needle-like shape of the particles of this clay explain its absorbency and it is rheological and catalytic properties, which make it a valuable material for a wide range of applications.

Chemically, sepiolite is a hydrated magnesium silicate with the ideal formula Si₁₂Mg₈O₃₀(OH)₄(OH₂)₄.8H₂O. Unlike other clays, Sepiolite is not a layered phyllosilicate.

Remediation of soil contaminated with heavy metals and wastewater treatment have become hot topics in environmental science and engineering. In the present invention, said sepiolite functionalized with alkoxysilane fractions has been used to improve bioremediation of oil pollutants in the marine environment.

Functionalization of Sepiolite

For the purposes of the present invention, sepiolite is functionalized so as to acquire specific characteristics such as increased hydrophilicity with respect to the aqueous matrix (such as, in this case, seawater), or lipophilicity, for a greater absorption of oil, with a quantitative reaction yield of 95%. Depending on the silane used, it is possible to change the final properties of the hybrid material in order to obtain, for example, materials that can also immobilize heavy metals.

In this sense, suitable silanes are:

(3 -glycidyloxypropyl)trimethoxy silane (GPTMS), hexadecyltrimethoxysilane (C16), diethoxy(3-glycidyloxypropyl)methylsilane, triethoxy(ethyl)silane, triacetoxy(methyl)-silane, tris(2-methoxyethoxy)(vinyl)silane, mpeg20k-silane, mpeg5k-silane, trichloro(phenyl)silane, trichloro(hexyl)silane, triethoxy(octyl)silane, trichloro-(phenethyl)silane, trimethoxy [2-(7-oxabicyclo[4.1.0]hept-3-yl)ethyl]silane, trichloro-(dichloromethyl)silane, silane A 174, triacetoxy(vinyl)silane, triethyl(silane-d), diphenyl(silane-d2), trimethoxy(propyl)silane, tris(trimethylsilyl)silane, trichloro-(octadecyl)silane, trimethoxy(octyl)silane, trimethoxy(octadecyl)silane, isobutyl-(trimethoxy) silane, triethyl(trifluoromethyl)silane, chloromethyl(dimethyl)silane, trichloro(octyl)silane, trimethyl(phenyl)silane, trimethyl(propargyl)silane, trimethyl-(trifluoromethyl)silane, tetrakis(trimethylsilyl)silane, tris (dimethylamino) silane, trimethyl(tributylstannyl)silane, trimethyl[(tributylstannyl)ethynyl]silane, tris(trimethylsiloxy)silane, tert-butyldimethyl(2-propynyloxy)silane, trimethoxy(7-octen-1-yl)silane, chlorotris(trimethylsilyl)silane, (3-aminopropyl)tris(trimethylsiloxy)silane, trimethoxy-[3-(methylamino)propyl]silane, trichloro(3,3,3 -trifluoropropyl)silane, trimethoxy(3,3,3-trifluoropropyl)silane, trimethyl(trifluoromethyl)silane solution, (3-mercaptopropyl)-trimethoxy-d9-silane, chloro-dimethyl(3,3,3-trifluoropropyl)silane, (3-chloropropyl)-tris(trimethylsiloxy)silane, chlorodimethyl(pentafluorophenyl)silane, butyldimethyl-(dimethylamino)silane, trimethoxy(2-phenylethyl)silane, trimethyl(phenylthio)silane, dimethoxy-methyl(3,3,3-trifluoropropyl)silane, tetrakis(trimethylsilyloxy)silane, tris(trimethylsiloxy)(vinyl)silane, trimethyl(phenoxy)silane, trimethyl(propoxy)silane, diisopropyl(3,3,4,4,5,5,6,6,7,7,8,8,9,9,10,10,10-heptadecafluorodecyl)silane, triethoxy-(1-phenylethenyl)silane, trichloro[2-(chloromethyl)allyl]silane, trimethyl(2,3,4,5-tetramethyl-2,4-cyclopentadien-1-yl)silane, trimethyl(methylthio)silane, chlorodi-methyl(2,3,4,5-tetramethyl-2,4-cyclopentadien-1-yl)silane, chlorotris(triethylsilyl)silane, trimethyl(phenylthiomethyl)silane, chlorotris(trimethylsilyl)silane solution, methyltris(tri-sec-butoxysilyloxy)silane, tris(triethylsilyl)silane, (chloromethyl)methyl-bis(pentafluorophenyl)silane, 3-methacrylamidopropyltris(trimethylsiloxy)silane, diisopropyl(3,3,4,4,5,5,6,6,6-nonafluorohexyl)silane, dimethyl-di(methacroyloxy-1-ethoxy)silane, isopropoxy(phenyl)silane, trichloro(1h,1h,2h,2h-perfluorooctyl)silane, chlorotrimethylsilane, dichlorodimethylsilane, vinyltrimethoxysilane, chlorotriethylsilane, methyltrichlorosilane, 3-(trimethoxysilyl)propylmethacrylate, chloro-dimethyl-octadecylsilanesolution, dichloro-methyl-octadecylsilane, dichloro(chloromethyl)methylsilane, cyanomethyl [3-(trimethoxysilyl)propyl]trithiocarbonate, 3-(triethoxysilyl)propylisocyanate, vinyltrimethylsilane, tetraallylsilane, isobutyltriethoxysilane, tris(dimethylsiloxy)phenylsilane, 1-phenyl-2-trimethylsilyl-acetylene, 3-trimethylsiloxy-1-propyne, chlorodimethylphenethylsilane, 2-(allyldimethylsilyl)pyridine, 3-[tris(trimethylsiloxy)silyl]propylmethacrylate, n-[3-(trimethoxysilyl)propyl]aniline, tetramethyl-d12 orthosilicate, 3-cyanopropyl-trichlorosilane, 2-(dimethylsilyl)pyridine, (2-thienyl)trimethylsilane, 5-(tert-butyldimethylsilyloxy)-1-pentyne,allyl(4-methoxyphenyl)dimethylsilane, n-octadecyltriethoxysilane, chloro(dimethyl)thexylsilane, 1h,1h,2h,2h-perfluoro-octyltriethoxysilane, silicon 2,3-naphthalocyanine bis(trihexylsilyloxide),1-(1-naphthyl)-2-(trimethylsilyl)acetylene, 2-tert-butyldimethylsiloxybut-3-yne, (e)-3-(tert-butyldimethylsilyloxy)propene-1-yl-boronic acid pinacolester, (3-phenylpropyl)silane, (1-bromo-2,2-diphenylcyclopropyl)(trimethyl)silane, (1-hydroxy-allyl)-tri-methyl-silane, (2,2-dibromocyclopropyl)(trimethyl)silane, (2-biphenylyl)tris(decyl)silane, (2-isopropyl-1-cyclopropen-1-yl)(triphenyl)silane, (2-methyl-1-cyclopropen-1-yl)(triphenyl)silane, (2-methyl-allyl)-triphenyl-silane, (3-biphenylyl)tris(3-phenyl-propyl)silane, (3-methyl-3-butenyl)(triphenyl)silane, (4-bromobutoxy)(trimethyl)silane, (4-chlorobenzoyl)(triphenyl)silane, (4-fluorobenzoyl)(triphenyl)silane, (4-iodo-1-butynyl)(trimethyl)silane, (4-methoxy-1-cyclohexen-1-yl)(trimethyl)silane, {[(4-methoxybenzyl)oxy]methyl}(trimethyl)silane, {[(4-methoxybenzyl)oxy]methyl}-(trimethyl)silane, [(4-methoxyphenoxy)methyl](trimethyl)silane, (4-methoxyphenyl)-tri(o-tolyl)silane, (4-methoxyphenyl)tris(4-(dimethylamino)phenyl)silane, (4-nitrobenzoyl)(triphenyl)silane, (4-phenoxyphenyl)(phenyl)(o-tolyl)silane, (4-tert-butyl-1-cyclohexen-1-yl)(trimethyl)silane,(4-tert-butylbenzoyl)(triphenyl)silane, (4-tert-butylcyclohexyl)(trimethyl)silane, (4-tert-butylphenyl)diphenyl(o-tolyl)silane, (5,5-dimethyl-1-cyclopenten-1-yl)(trimethyl)silane,(5-iodo-1-pentynyl)(trimethyl)silane, (6,6-dimethyl-1-cyclohexen-1-yl)(trimethyl)silane, (7-bromo-2-aphthyl)(trimethyl)-silane, (9,10-dihydro-9-anthracenyl)trimethyl-silane, (chloromethyl)dimethyl(pentafluorophenyl)silane, (o-tolyloxy)tri(o-tolyl)silane, (p-tolyl)tris(1-naphthyl)silane, 1,3-diphenyl-1-propenyloxy(dimethyl)(pentafluorophenyl)silane, 1,3-diphenyl-1-propenyloxy(dimethyl)(trimethylsilylmethyl)silane, [1-(1-chloro-2-cyclopropylidene-ethyl)cyclopropyl](trimethyl)silane,[1-(1-cyclohexen-1-yl)cyclopropyl](trimethyl)silane, [1-(bromomethyl)cyclopropyl](trimethyl)silane, [1-(cyclohexylidenemethyl)cyclopropyl](trimethyl)silane, [1-(cyclopentylidenemethyl)cyclopropyl](trimethyl)silane, [1-(dimethoxymethyl)cyclopropyl](trimethyl)silane, 1-cyclododecen-1-yl(trimethyl)silane, 1-cyclohepten-1-yl(trimethyl)silane, 1-cyclopenten-1-yl(trimethyl)silane, [2-(cyclohexylmethyl)-2-propenyl](trimethyl)silane, [2-chloro-2-(phenylsulfonyl)ethyl](trimethyl)silane, 2-cyclohexen-1-yl(trimethyl)silane, 2-cycloocten-1-yl(trimethyl)silane, allyl(methyl)1-naphthyl(phenyl)silane, benzoyl(tris(4-tert-butylphenyl))silane, benzyl(3-phenylpropyl)silane, benzyltris(3-phenylpropyl)-silane, benzyltris(p-terphenylyl)silane, bis(2-chlorobenzyl)silane, bis(3-phenylpropyl)silane, butyldimethyl(2,3,4,5-tetrafluorophenyl)silane, butyldimethyl(2,3,5,6-tetrafluoro-phenyl)silane, butyldimethyl(pentafluorophenyl)silane, chlorodiphenyl(diphenyl-methyl)silane, chloromethyl-triethyl-silane, chloromethyldimethyl(pentachloro-phenyl)silane, chlorotri(2-biphenylyl)silane, chlorotri(o-tolyl) silane, chlorotris (1-naphthyl) silane, chlorotris (2-methoxyphenyl) silane, dibenzyldi(m-tolyl) silane, dicyclohexyl-methyl-silane, dimethyl(2,3,5,6-tetrafluorophenyl) silane, dimethyl(2,3,6-trichlorophenyl) silane, dimethyl(2,4,6-trichlorophenyl) silane, dimethyl(3,4,5-trichloro-2-thienyl)silane, dimethyl(3-(pentachlorophenyl)propyl)(pentafluorophenyl) silane, dimethyl(3-phenylpropyl)silane, dimethyl(diphenylmethoxy)(pentafluorophenyl)silane, dimethyl(pentachlorophenyl)silane, dimethyl(pentafluorophenyl)(3-(pentafluoro-phenyl)propyl) silane, diphenyl(1-naphthyl)silane, diphenyl(3-phenylpropyl)silane, diphenyl(4-methoxyphenyl)silane, diphenyl(4-phenoxyphenyl)silane, diphenyl(9-fluorenyl)silane, diphenyl(diphenylmethoxy)(diphenylmethyl)silane, diphenyl(diphenyl-methyl)silane, diphenyl(m-tolyl)silane, diphenyl(o-tolyl) (4-trimethylsilyl)phenyl) silane, diphenyl(p-tolyl)silane, diphenyl(pentachlorophenyl)silane, diphenyldi(m-tolyl)silane, diphenyldi(o-tolyl)silane, diphenylmethyl(o-tolyl)silane, diphenylmethyl(pentachloro-phenyl)silane, diphenylmethyl(pentafluorophenyl)silane, diphenylphenethyl(o-tolyl)silane, dodecyltris(2-biphenylyl)silane, dodecyltris(2-cyclohexylethyl)silane, dodecyltris(3-chlorophenyl)silane, dodecyltris (3-fluorophenyl)silane, dodecyltris(m-tolyl)silane, ethoxytri(o-tolyl)silane, ethoxytris(2-methoxyphenyl)silane, ethyl-bis-(2,4,6-trimethyl-phenyl)-silane, ethylenebis(tris(decyl)silane), hexadecyl-sulfanylethynyl-trimethyl-silane, hexadecyltris(3-chlorophenyl)silane, hexadecyltris(3-fluorobenzyl)silane, hexadecyltris(3-phenylpropyl)silane, hexadecyltris(4-chloro-phenyl)silane, methylphenyl(-(trimethylsilylmethyl)phenyl)silane, methylphenyl(m-tolyl)silane, methyltris(2-methoxyethoxy)silane, methyltris(3,4,5-trichloro-2-thienyl)silane, methyltris(p-terphenyl-4-yl)silane, methyltris(pentafluorophenyl)silane, octadecyltris(2-biphenylyl) silane, octadecyltris(2-cyclohexylethyl)silane, octadecyltris-(3-chlorophenyl)silane, octadecyltris(3-fluorophenyl)silane, octadecyltris(4-chlorophenyl)silane, phenyl(o-tolyl)silane, phenyltri(m-tolyl)silane, phenyltri(o-tolyl)silane, phenyltri(p-tolyl)silane, phenyltris(2-cyclohexylethyl)silane, phenyltris (2-ethyl-hexyl)silane, phenyltris(3-fluorophenyl)silane, phenyltris(3-phenylpropyl)silane, phenyltris(4-(trimethylsilyl)phenyl)silane, phenyltris (4-fluorobenzyl)silane, phenyltris(9-ethyl-3-carbazolyl)silane, phenyltris (9-fluorenyl)silane, phenyltris(p-terphenylyl)silane, tert-butyl(dimethyl)[(2e)-2,4-pentadienyloxy]silane, tetra(phen-ethyl)silane, tetrakis((p-tolyl)thiomethyl)silane, tetrakis((trimethylsilyl)methyl)silane, tetrakis(2-cyclohexylethyl)silane, tetrakis(2-ethylhexyl)silane, tetrakis(2-methoxyphenyl)silane, tetrakis(2-naphthyl)silane, tetrakis(3,4,5-trichloro-2-thienyl)-silane, tetrakis(3-(trifluoromethyl)phenyl)silane, tetrakis(3-chlorophenyl)silane, tetrakis(3-fluorophenyl)silane, tetrakis(3-phenylpropyl)silane, tetrakis(4-(dimethyl-amino)phenyl)silane, tetrakis(4-(trimethylsilyl)phenyl)silane, tetrakis(4-biphenylyl)-silane, tetrakis(dimethylphenylsilyl)silane, tetrakis(p-tolyl)silane, tetrakis(pentafluorophenyl)silane, tetrakis(phenylthiomethyl)silane,tetrakis(triphenylstannyl)silane, trans-styryltris(pentafluorophenyl)silane, tri(o-tolyl)silane, triethyl(triphenylgermyl)silane, trihexadecyl(4-(trimethyl silyl)phenyl)silane, trimethyl[(1z)-1-propyl-1-butenyl]silane, trimethyl[(2e)-3-phenyl-2-propenyl]silane, trimethyl[1-(trimethylsilyl)vinyl]silane, trimethyl[2-[(trimethylsilyl)methyl]-2-propenyl]silane, trimethyl[2-(1-phenylvinyl)-cyclopropyl]silane, trimethyl[6-(trimethylsilyl)-1,5-hexadiynyl]silane, trimethyl(1-methyl-1,2-diphenylethyl)silane, trimethyl(1-naphthylmethyl)silane, trimethyl(1-phenyl-2-propenyl)silane, trimethyl(3-phenyl-2-cyclohexen-1-yl)silane, trimethyl(4-(trimethylsilyl)butoxy)silane, trimethyl(4-methyl-1,5-cyclohexadien-1-yl)silane, trimethyl(4-methyl-3-penten-1-ynyl)silane, trimethyl(5-methyl-1,5-cyclohexadien-1-yl)silane, trimethyl(6-methyl-1-cyclohexen-1-yl)silane, trimethyl(6-phenyl-1-cyclo-hexen-1-yl)silane, trimethyl(pentafluorophenyl)silane, trimethyl-(1-methyl-1-phenylpropoxy)silane, trimethyl-(4-nitro-phenylethynyl)-silane, triphenyl(1,2,2-triphenylethyl)silane, triphenyl(3-(triphenylgermyl)propyl)silane, triphenyl(triphenylmethyl)silane, triphenyl(undecyl)silane, tris(1-naphthyl)silane, tris(2-biphenyl)silane, tris(2-chlorobenzyl)silane, tris(3,4,5-trichloro-2-thienyl)silane, tris(3-biphenylyl)silane, tris(4-(trimethylsilyl)phenyl)silane, tris(4-bromophenyl)silane, tris(decyl)silane, tris(hexadecyl)silane, tris(pentachlorophenyl)silane, tris(pentafluorophenyl)silane, tris(phenethyl)silane, ([4,4-dimethyl-3-[2-(2-methyl-1,3-dioxolan-2-yl)ethyl]-1-cyclo-penten-1-yl]oxy)(trimethyl)silane, ((1e)-3-[[tert-butyl(dimethyl)silyl]oxy]-1-propenyl)(trimethyl)silane, {[(1r,2s,5r)-2-isopropyl-5-methylcyclohexyl]oxy}(methyl)1-naphthyl-(phenyl)silane, {[(1r,2s,5r)-2-isopropyl-5-methylcyclohexyl]oxy}(trimethyl)silane, {[(1s)-1-isopropyl-5,5-dimethyltricyclo[4.1.0.0(2,4)]hept-4-yl]oxy}(trimethyl) silane, [(1z)-1-ethyl-1-propenyl](methyl)1-naphthyl(phenyl)silane, (2-{[(3-bromo-2-cyclo-hexen-1-yl)oxy]methoxy}ethyl)(trimethyl)silane, [(2-isopropyl-5-methylcyclohexyl)-oxy](methyl)1-naphthyl(phenyl)silane, [[(2s)-3-chloro-3,7,7-trimethyltricyclo-[4.1.1.0(2,4)]oct-2-yl]oxy](trimethyl)silane, (4,4-dimethyl-1,5-cyclohexadien-1-yl)-(methyl)1 1-naphthyl(phenyl)silane, [(4s,5r)-5-ethyl-4-methyl-1-cyclopenten-1-yl](trimethyl)silane, (6-isopropyl-3-methyl-1-cyclohexen-1-yl)(trimethyl)silane, [1-[(1z)-1-ethyl-1-propenyl]cyclopropyl](trimethyl)silane, [1-[(2,6-dimethyl-2-cyclohexen-1-ylidene)methyl]cyclopropyl](trimethyl)silane, [1-[(7,9-dimethyl-1,4-dioxaspiro-[4.5]dec-8-ylidene)methyl]cyclopropyl](trimethyl)silane, [1-[bis(phenylsulfanyl)-methyl]cyclopropyl](trimethyl)silane, 1-cyclohexen-1-yl(methyl)1-naphthyl(phenyl)-silane, 1-cycloocten-1-yl(methyl)1-naphthyl(phenyl)silane, 1-oxaspiro[2.2]pent-4-yl(triphenyl)silane, [2,2-dimethyl-3-(tetrahydro-2h-pyran-2-yloxy)propoxy](trimethyl)-silane, [2-({[(2e,6s)-2,6-dimethyl-7-(2-oxiranyl)-2-heptenyl]oxy}methoxy)ethyl]-(trimethyl)silane, [2-([[tert-butyl(dimethyl)silyl]oxy]methyl)-2-propenyl](trimethyl)-silane, [3,7-dimethoxy-6-(trimethylsilyl)dibenzo[b,d]furan-4-yl](trimethyl)silane, [3-([[tert-butyl(dimethyl)silyl]oxy]methyl)-2,2-dichlorocyclopropyl](trimethyl)silane, 6,9-dihydro-5h-benzo[a]cyclohepten-7-yl(trimethyl)silane, bicyclo[2.2.2]oct-2-yl(trimethyl)silane, bicyclo[3.1.0]hex-6-yl(trimethyl)silane, bicyclo[3.2.1]oct-2-en-3-yl-(trimethyl)silane, bicyclo[4.1.0]hept-2-en-7-yl(trimethyl)silane, bis(pentafluorophenyl)methyl(alpha-styryl)silane, dimethylphenyl(phenyl(2,3,5,6-tetrachloro-4-pyridyl)methoxy)silane, methyl(4-methyl-1-cyclohexen-1-yl)1-naphthyl(phenyl)silane, tert-butyl(dimethyl)[(1,7,7-trimethylbicyclo[2.2.1]hept-2-en-2-yl)oxy]silane, tert-butyl(dimethyl)[[(2r)-2-methyl-3-(phenylsulfonyl)propyl]oxy]silane, tert-butyl(dimethyl)-[(3,3,9,9-tetrachlorotricyclo[6.1.0.0(2,4)]non-6-yl)oxy]silane, tert-butyl(dimethyl)[(4-methyl-4-pentenyl)oxy]silane, tert-butyl(dimethyl)[(5s)-tricyclo[6.1.0.0(2,4)]non-6-en-5-yloxy]silane, tert-butyl(dimethyl){2-methyl-2-[(2s)-2-oxiranyl]propoxy}silane, tert-butyl(dimethyl){[3-(trimethylstannyl)-3-butenyl]oxy}silane, tert-butyl(dimethyl)[[4-(tributylstannyl)-3-furyl] methoxy]silane, tert-butyl(dimethyl)(tetracyclo-[7.1.0.0(2,4).0(5,7)]dec-8-yloxy)silane, tert-butyl(diphenyl)(2,3,5,6-tetrabromo-4-{[tert-butyl(diphenyl)silyl]oxy}phenoxy)silane, tert-butyl-(2,2-dimethyl-(1,3)dioxolan-4-ylmethoxy)-diphenyl-silane, trimethyl[(1e)-1-methyl-3-(triphenylstannyl)-1-propenyl]-silane, trimethyl{(3s)-4-methyl-2-(phenylsulfonyl)-3-[(phenylsulfonyl)methyl]pentyl}-silane, trimethyl[(4-methyl-3-cyclohexen-1-yl)methyl]silane, trimethyl[1-[(2-methyl-2-cyclohexen-1-ylidene)methyl]cyclopropyl]silane, trimethyl[1-(7-oxabicyclo-[4.1.0]hept-1-yl)cyclopropyl]silane, trimethyl[2-[8-(phenylsulfonyl)-1,4-dioxaspiro-[4.5]dec-8-en-7-yl]ethyl]silane, trimethyl[2-({[(2s)-2-methyl-3-butynyl]oxy}methoxy)ethyl]silane, trimethyl(13-oxabicyclo[10.1.0]tridec-1-yl)silane, trimethyl(2-phenyl-1,1-bis(trimethyl-silyl)ethyl)silane, trimethyl(6-phenyl-7-oxabicyclo[4.1.0]hept-2-yl)silane, trimethyl(7-oxabicyclo[4.1.0]hept-1-yl)silane, trimethyl(spiro[4.5]dec-6-en-6-yl)silane, trimethyl-(tricyclo[4.1.0.0(2,7)]hept-1-yl)silane, trimethyl-(4′-naphthalen-1-yl-biphenyl-4-yl)-silane, ({2-[2-(methoxymethoxy)ethyl]-5,5-bis[(3e)-5-(phenylsulfanyl)-3-pentenyl]-1-cyclopenten-1-yl}oxy)(trimethyl)silane, ({4-[1-({[tert-butyl(dimethyl)silyl]oxy}-methyl)-2-methylpropyl]-2-methyl-1,5-cyclohexadien-1-yl}oxy)(trimethyl)silane, {[(1ar,3r,11as,11br)-3-methoxy-1,1-dimethyl-1a,2,3,5,6,7,10,11,11a,11b-decahydro-1h-cyclopropa[3,4]benzo[1,2-a]cyclodecen-9-yl]oxy}(trimethyl)silane, [[(1r,2ar,4ar,6as,6br)-1-vinyl-1,2,2a,4a,6a,6b-hexahydrocyclopenta[cd]pentalen-1-yl]oxy](trimethyl)-silane, (2,6-ditert-bu-4(3,5-ditert-bu-4((tri-me-silyl)oxy)benzyl)phenoxy)(tri-me)silane, (2-{[((2s,4as,5s,7s,7ar)-5-ethoxy-7-(iodomethyl)-2-(4-methoxyphenyl)dihydro-4h-furo [3,4-d][1,3]dioxin-4a(5h)-yl)oxy]methoxy}ethyl)(trimethyl)silane, (2-{[((2s,4as,7s,7ar)-5-ethoxy-7-(iodomethyl)-2-(4-methoxyphenyl)dihydro-4h-furo[3,4-d][1,3]-dioxin-4a(5h)-yl)oxy]methoxy}ethyl)(trimethyl)silane, [[(4s,4ar,5r,6s,8ar)-4-(3-butenyl)-3,4a,6-trimethyl-5-(3-methyl-3-butenyl)-1,4,4a,5,6,7,8,8a-octahydro-2-naphthalenyl]oxy](trimethyl)silane, {2,6-ditert-butyl-4-[{3,5-ditert-butyl-4-[(trimethylsilyl)oxy]pheny}(ethoxy)methyl]phenoxy}(trimethyl)silane, [2-[([(1s,3as,7ar)-3a-[(2-methoxyethoxy)methoxy]-7a-methyl-2,3,3a,6,7,7a-hexahydro-1h-inden-1-yl]oxy)methoxy]ethyl](trimethyl)silane, [2-({[(1r,3r,6s)-7,7-dimethyl-4-methylenebicyclo[4.1.0]hept-3-yl]oxy}methoxy)ethyl](trimethyl)silane, [2-({[(1s,6r)-3-bromo-7-oxabicyclo[4.2.0]oct-2-en-1-yl]oxy}methoxy)ethyl](trimethyl)silane, [2-({[(2e,6s)-7-(1,3-dithian-2-yl)-2,6-dimethyl-2-heptenyl]oxy}methoxy)ethyl](trimethyl)silane, [2-({[(2e,6s)-9-iodo-2,6-dimethyl-8-(tetrahydro-2h-pyran-2-yloxy)-2-nonenyl]oxy}-methoxy)ethyl](trimethyl)silane, tert-butyl(dimethyl)[[(2s,4s)-4-(2-phenylethyl)-3,4-dihydro-2h-pyran-2-yl]methoxy]silane, triethyl[((4z)-5-{(2s,3r)-2-methoxy-3-[(4-methoxybenzyl)oxy]-7,7-dimethyl-1-vinylbicyclo[2.2.1]hept-2-yl}-3-methylene-4-pentenyl)oxy]silane, trimethyl[[(1s,5r,6r,7r)-7-methyl-7-vinylbicyclo[3.2.0]hept-2-en-6-yl]oxy]silane, trimethyl[1-methyl-2-({1-[7-(1-{1-methyl-2-[(trimethylsilyl)oxy]-propoxy}vinyl)-2-naphthyl]vinyl}oxy)propoxy]silane, trimethyl({(4s)-4-methyl-3-[2-(2-methyl-1,3-dioxolan-2-yl)ethyl]-1-cyclopenten-1-yl}oxy)silane, ({(1bs,4ar,7ar,7br,8r)-1,1,8-trimethyl-7b-[(trimethylsilyl)oxy]-1a,1b,2,4a,5,6,7,7a,7b,8,9,9a-dodeca-hydro-1h-cyclopropa[3,4]benzo[1,2-e]azulen-4-yl}oxy)(trimethyl)silane, [(2r,3s,4r,5r,6s)-2-(iodomethyl)-6-{[(2r,3s,4s,5r,6s)-6-(iodomethyl)-3,4,5-tris(trimethylsilyl)tetrahydro-2h-pyran-2-yl]oxy}-4,5-bis(trimethylsilyl)tetrahydro-2h-pyran-3-yl](trimethyl)silane, {2-[({(3ar,5s,5ar,6s,9s,9br)-9-{[tert-butyl(dimethyl)silyl]oxy}-9b-[3-(methoxymethoxy)propyl]-2,3,3,5a-tetramethyl-5-[(triethylsilyl)oxy]-3a,4,5,5a,6,7,8,9,9a,9b-decahydro-3h-cyclopenta[a]naphthalen-6-yl}oxy)methoxy]-ethyl}(trimethyl)silane, 2,4,6,8-tetramethylcyclotetrasiloxane, ethynyltrimethylsilane, triethoxymethylsilane, trimethoxymethylsilane, triethoxyvinylsilane, hexachlorodisilane, dimethoxydimethylsilane, methoxytrimethylsilane, diethoxydimethylsilane,trichlorovinylsilane, methyldiethoxysilane, bis(trimethylsilyl)acetylene, ethoxytrimethylsilane,dimethoxymethylvinylsilane, tert-butyltrichlorosilane, (chloromethyl)triethoxysilane, trans-1-methoxy-3-trimethylsiloxy-1,3-butadiene, 1,2-bis(triethoxysilyl)ethane, 1,2-bis(trimethoxysilyl)ethane, 1,2-bis(trichlorosilyl)ethane, 1,3-diethoxy-1,1,3,3-tetramethyldisiloxane, (3-aminopropyl)triethoxysilane, (triiso-propylsilyl)acetylene, tetraethylorthosilicate, diethoxy(3-glycidyloxypropyl)-methylsilane, (3-mercaptopropyl)trimethoxy silane, triethoxysilane,tetramethylsilane, phenylsilane, hexamethyldisiloxane, diphenylsilane, bromotrimethylsilane, tetramethylorthosilicate, triphenylsilane, diphenylsilanediol, dichlorodiphenylsilane, chlorotriphenylsilane, triphenylsilanol, allyltrichlorosilane, triethoxyphenylsilane, trihexylsilane, benzyldimethylsilane,tetravinylsilane, chlorotributylsilane, trichlorododecylsilane, chlorotrihexylsilane, hexamethyldisiloxane solution, chlorotrimethylsilanesolution, dichlorophenylsilane, tributylchlorosilane, dodecyltriethoxysilane, diethoxydiphenylsilane, hexylsilane, trioctylsilane, chlorotripropylsilane, (3-chloropropyl)triethoxysilane, 3-(triethoxysilyl)propionitrile, (chloromethyl)dimethylphenylsilane, (3-chloropropyl)trichlorosilane, trichloromethyl-silane, bis(dimethylamino)dimethylsilane, 3-(2-aminoethylamino)propyldimethoxy-methylsilane, trichlorocyclopentylsilane, (3-aminopropyl)trimethoxysilane, (2-bromoethoxy)-tert-butyldimethylsilane, methoxy(dimethyl)octylsilane, tert-butyldimethylsilylglycidylether, (3-bromopropyl)trimethoxysilane, methoxy(dimethyl)-octadecylsilane, dimethyloctadecyl[3-(trimethoxysilyl)propyl]ammoniumchloride solution, tetrafluoro-2-(tetrafluoro-2-iodoethoxy)ethanesulfonylfluoride, [3-(2-aminoethylamino)propyl]trimethoxysilane, (3-glycidyloxypropyl)triethoxysilane, (3-bromopropoxy)-tert-butyldimethylsilane.

The sol-gel technique is a very simple synthetic method which allows the formation of an inorganic/organic siliceous-based network. The network is formed through hydrolysis and condensation of a metal-organic precursor, such as an alkoxide M(OR)ₙ. The organic molecules can be incorporated into this solid matrix, giving rise to a functionalized sol with high thermal and mechanic stability.

In this sense, the trialkoxysilanes are preferably functional molecules which can be utilised as cross-linking reagents for the functionalization of appropriate nanofillers and the dispersion thereof inside a sol-gel-based hybrid polymeric matrix, allowing the formation of a nanohybrid material or of a functional nanocomposite, is also utilizable for coating surfaces. Functionalizable surfaces can include textile fibres which, after the application of functional coatings, can be used to create technical, innovative, or smart fabrics. Indeed, natural plant fibres, such as cotton, are mainly compounds of cellulose, a natural polymer which has as its structural unit glucose joined with β-glycosidic bonds and features external —OH groups. These functional groups lend themselves well to the grafting processes which allow the inclusion—therewithin or on the surface of fabric—of a different type of nanostructure, to introduce a new functions or implement the physical/mechanical properties of cotton fibres.

Preferred trialkoxysilanes are those comprising at least one epoxydic group, also known as epoxydic trialkoxysilanes, which lend the sepiolite specific characteristics such as increased hydrophilia, in relation to the aqueous matrix (such as, on this case, sea the water). Preferably then, said at least one cross-linking agent is an epoxydic trialkoxysilane.

Among the suitable epoxydic trialkoxysilanes, 3-glycidoxypropyltrimethoxysilane (GPTMS) is particularly preferred.

In order to create the sol-gel matrices, wherein including the nanofillers of organic or inorganic origin, which were then also applied to the fabrics, so as to implement the physical/chemical properties and the mechanical characteristics of the sepiolite and of the fabric fibres, it was decided to modify a sol-gel synthesis approach, based on GPTMS:

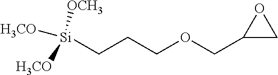

The 3-glycidoxypropyltrimethoxysilane or GPTMS acts as a linker between the fabric and said nanofiller. Indeed, owing to its bifunctionality, through its trimethoxysilane end, GPTMS allows the formation of a sol-gel network or anchorage to the sepiolite or to the fabric, through condensation with —OH groups, and release of MeOH, while—through the epoxydic ring (following a nucleophile coupling with consequent opening of said ring)—it produces the formation of a heterolytic covalent bond in the presence of a nucleophile:

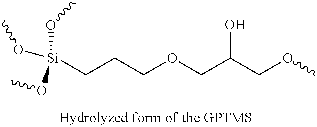

The synthesis of hybrid materials based on the GPTMS epoxydic molecule is therefore a process involving multiple steps, comprising the formation of a siliceous-based network and the functionalization of the epoxide, with the opening of said epoxydic ring.

When instead it is desirable to increase the lipophilia of the sepiolite and consequently the affinity for oil of the end hybrid material, then long-chain aliphatic trialkoxysilanes are preferred. Preferably then, said at least one cross-linking agent is aliphatic trialkoxysilane having the following formula (I):

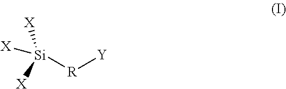

where X is an alkoxy group, and R is a C4-C20 aliphatic chain, and Y is methyl, an amine group or a thiol group.

Among the long-chain aliphatic trialkoxysilanes, hexadecyltrimethoxysilane (C16) is particularly preferred as it features both a trimethoxysilane group which can be coordinated with the sepiolite and a long hydrocarbon tail:

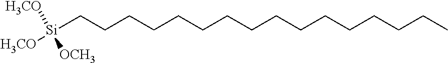

In preferred embodiments, the functionalized hybrid material comprises sepiolite functionalized with a mixture of a) at least one epoxydic trialkoxysilane and b) at least one aliphatic trialkoxysilane having formula (I).

In particularly preferred embodiments, the functionalized hybrid material comprises sepiolite functionalized with a mixture of a) at least one trialkoxysilane epoxydic and b) at least one aliphatic trialkoxysilane having formula (I), wherein a) and b) are in a weight ratio of 5:1 to 1:5.

More preferable are the embodiments wherein the functionalized hybrid material comprises sepiolite functionalized with a mixture of GPTMS and C16, wherein GPTMS and C16 are in a weight ratio of 2:1 to 1:2. Preferably, said mixture and said sepiolite are in a weight ratio of 2:1 to 1:2, more preferably about 1:1.

The common feature of sepiolite nanofibres is that they have external and internal —OH groups, as well as water molecules. These groups allow an alkoxysilane to be anchored to said structure, which could then be used as a linker with the —OH groups belonging to the glucose molecules of cellulose, which is a constituent of cotton. The use of the molecule 3-glycidoxypropyltrimethoxysilane, or GPTMS, is therefore particularly suitable, as it can bind—through the methoxysilane end—to the nanofillers by condensation with the —OH group and release of MeOH, and in any case it has an epoxy group which is available, in the presence of a suitable catalyst, to open following nucleophilic coupling by the —OH groups of the cellulose or by a chromophore or other molecule present in the solution, to which it binds by an ester bridge.

In another aspect, the present invention also concerns a process for the preparation of the functionalized hybrid material comprising the following steps:

1) providing sepiolite,

2) adding the alkoxysilane cross-linking agent,

3) adding water, an organic solvent, or a mixture thereof, and preferably adjusting the pH to neutral,

4) leaving to react under stirring for at least 6 hours,

5) separating the sepiolite thus functionalized, and

6) desiccating, thus obtaining the functionalized hybrid material.

In preferred embodiments, the pH is adjusted by adding NaOH or KOH.

For the syntheses, various organic and halogenated solvents can be utilised. Suitable solvents include: acetaldehyde, acetic acid, acetylacetone, acetone, acetonitrile, acrylamide, acrylic acid, acrylonitrile, acrolein, iso-amyl alcohol, 2-aminoethanol, iso-amyl acetate, aniline, anisole, benzene, benzonitrile, benzyl alcohol, n-butanol, 1-butanol, 2-butanol, i-butanol, 2-butanone, t-butyl alcohol, iso-butyric acid, n-butyl acetate, iso-butyl acetate, di-n-butyl phthalate, chlorobenzene, carbon disulphide, carbon tetrachloride, chlorobenzene, chloroform, cyclohexane, cyclohexanol, cyclohexanone, p-cymene, n-decane, 1,1-dichloroethane, 1,2-dichloroethane, cis-1,2-dichloroethylene, o-dichlorobenzene, diethylene glycol, diglyme, dimethoxyethane, N, N-dimethylaniline, dimethylformamide (DMF), dimethyl phthalate, dimethyl sulphoxide (DMSO), dioxane, 1,4-dioxane, ethanol, ether, ethyl acetate, ethyl acetoacetate, ethyl acrylate, ethylbenzene, ethyl benzoate, diethyl ether, glycerin, n-heptane, 1-heptanol, n-hexane, 1-hexanol, 2-hexanone, hexamethylphosphoramide (HMPA), hexamethyl phosphoric triamide (HMPT), methanol, methacrylic acid, methyl acetate, methyl acrylate, methylcyclopentane, methyl cyclohexane, 2-methylcyclohexanone, methyl methacrylate, methyl t-butyl ether (MTBE), methyl t-methyl chloride, methyl t-methyl chloride, methyl t-butyl methyl, Nitrile acrylonitrile, n-nonane, 1-octanol, iso-octane, n-octane, pentane, 1-pentanol, 2-pentanol, 3-pentanol, 2-pentanone, 3-pentanone, 1-propanol, 2-propanol, n-propionic acid, iso-propyl acetate, n-propyl acetate, pyridine, styrene, 1,1,1-trichloroethane, 1,1,2-trichloroethane, 1,1,2,2-tetrachloroethane, trichlorethylene, tetrachlorethylene, tetrahydrofuran (THF), toluene, water, heavy water, p-xylene, m-xylene, o-xylene, or mixtures thereof.

Three different preparation approaches were preferably followed, in particular when that functionalization involves GPTMS and C16:

(i) in water with BF₃O (C₂H₅) as a catalyst;

(ii) in ethanol using traces of acid (HCl) as a catalyst; or

(iii) with KOH in water, alcoholic solvents, organic solvents (toluene, THF), and halogenated solvents.

Various tests were performed before optimizing the reaction conditions, in terms of solvent, volume, catalyst concentration, nano-material and GPTMS, which allowed the best homogeneous sols and the lowest insoluble residue.

In the first aqueous or ethanolic solutions, the predetermined amounts of catalyst (BF₃ or HCl) were added entirely at one time; this led to the formation of an insoluble residue within a few hours of the start of the reaction, thus decreasing the concentration of the sol.

In an attempt to avoid or limit the formation of insoluble material, the catalyst was then diluted; furthermore, it was added gradually in order to govern the reaction speed of the GPTMS on the nanofillers. In the case of the ethanolic solutions, it was decided to use a reflux temperature (T=70° C.) to activate the GPTMS siloxanes. In any case, the pH of the solution was brought back to a neutral value, at the end of the reaction, to stop said reaction. Finally, the solution was filtered with a Millipore filter to eliminate the insoluble component.

The following preparation processes are therefore particularly preferred:

a) Aqueous solution procedure: 200 mg sepiolite was dissolved in 200 ml aqueous solution, vigorous stirring was started, then 7 g 97% GPTMS was injected, and a 50 mL aqueous solution was prepared with 0.35 g BF₃, which was added at a rate of 10 mL every 30 minutes. The total reaction time starting from the first addition of BF₃ was approximately 24 hours, at the end of which the pH of the solution was checked and brought to above 5 with a small amount of 0.1M NaOH. The solution was then filtered with a Millipore filter to separate it from the undissolved part.

b) Ethanolic solution procedure: 200 mg sepiolite was dissolved in 200 mL ethanolic solution, under stirring at 70° C. in a continuous reflux setup. Immediately afterwards, 97% GPTMS and 2 mL 0.1 M HCl were added as a catalyst. The total reaction time starting from the addition of HCl was approximately 24 h, at the end of which the pH of the solution was checked and brought to above 5 with a small amount of 0.1M NaOH. The solution was then filtered with a Millipore filter to separate it from the undissolved part and then applied

c) Procedure with various solvents with GPTMS and C16: 3 g sepiolite was reacted with 3 mL GPTMS (or C16, or GPTMS+C16) with KOH (2 tablets, about 300 mg), in 50 mL alcoholic solvents, organic solvents (e.g. toluene, THF) or halogenated solvents, in a reflux setup overnight.

d) Procedure c) with various solvents: with or without KOH (2 tablets, approximately 300 mg), in 50 mL alcoholic solvents, organic solvents (e.g. toluene, THF) or halogenated solvents, in a reflux setup overnight.

Procedures a) and b) were intended to fix the sepiolite on the fabric.

Procedure c) was used to obtain the solid material which is subsequently used in microbiological tests.

Procedure d) was the procedure performed using various solvents.

Functionalization of Fabrics and Other Surfaces

The hybrid materials thus obtained, preferably in water and ethanol, containing functionalized sepiolite, were applied to both natural and synthetic fibre fabrics.

The fabrics were functionalized by impregnating the aforesaid hybrid materials with sols.

Preferably, after the impregnation step, the fabrics are dried and then washed, sometimes several times.

In preferred embodiments, said fabrics are made of cotton or polyester fibre.

In other preferred embodiments, following impregnation, the fabric is first wrung between two rollers to quickly remove most of the solvent, and then undergoes heat treatment in the oven, to complete the drying.

Functionalization of the fabrics takes place preferably through the coupling of the epoxide of the alkoxysilane cross-linking agent on the structure of the fabrics. In the case of cotton, the —OH groups of glucose, a constituent molecule of cellulose fibres, are coupled by the epoxide. This whole process takes place during the polymerization of the alkoxysilane cross-linking agent with immobilization of the nano-structures within the sepiolite.

A preferred synthetic fabric is polyethylene terephthalate (PET), which is a type of polyester which is advantageous due to: (i) its excellent physical and chemical properties; (ii) its hydrophobic nature; and (iii) its highly compact molecular structure. The rigidity of the fabrics created increases according to the number of layers of sol-gel applied. At first glance, fabrics of the same type (e.g. all cottons) do not appear to be very different from one another. They are rough to the touch, which indicates that the application has been performed, and remain so even after 5 washing cycles, after which only in a few cases is a slight softening is perceived; this suggests that a small amount of sol, after not reacting correctly with the fabric, is lost in the wash, as confirmed by subsequent weighing. They are more rigid than non-applied fabrics and have low sol losses after washing.

By also adding alkoxysilanes with a suitable functionality (for example SH, NH₂), the hybrid materials according to the invention can also be utilized to entrap metal cations and heavy metals (the most common environmental pollutants include: Sn²⁺, Cd²⁺, Zn²⁺, Hg²⁺, Pt²⁺, Cu²⁺) dissolved in aqueous solution.

Furthermore, products were developed in alternative or to complement the functionalized fabrics, such as for example polymeric foams and sponges.

As will also be seen from the examples below, one of the most significant advantages of the material according to the present invention is the induction of bacterial degradation by hydrocarbonoclastic bacteria (i.e. HCB), with an 80% reduction in oil after approximately 2 weeks, and equal increase in bacterial counts (as in the presence of nutrients), in addition to the absorption and the buoyancy of the material on the surface of the water.

In a further aspect, therefore, the present invention relates to the use of this functionalized hybrid material as a substrate for absorbing and degrading hydrocarbon pollutants, by activating hydrocarbonoclastic bacteria, for environmental recovery and remediation.

In a still further aspect, the present invention regards a product for environmental remediation and recovery, comprising said functionalized hybrid material, said product being a fabric, a sponge or a polymeric foam.

In an additional aspect, the present invention regards a method for environmental remediation and recovery, through the use of the functionalized hybrid material and the product comprising the same.

It should be understood that all the possible combinations of the preferred aspects of the components of the hybrid material disclosed above are described herein and therefore are also preferred.

It should also be understood that all aspects identified as preferred and advantageous for the hybrid material should be deemed to be similarly preferable and advantageous also for the preparation and the uses of said hybrid material.

Below are working examples of the present invention provided for illustrative purposes.

### EXAMPLES

### Example 1

### Materials and Methods

The microcosm systems were developed in sterilized 250 mL Erlenmeyer flasks. The microcosms were incubated at 22±1° C. for 7 days under stirring (100 rpm). All experiments were carried out twice.

In the first experiment (referred to as “SW”), natural seawater was used (which was not sterilized in all the experiments); in the second experiment (referred to as “SW+IN”), the microcosms were made in sterile natural seawater with added inorganic nutrients (10:1 vol/vol) to reach higher concentrations than those obtained in natural water (final concentrations: KH₂PO₄ 0.077 g L⁻¹, NH₄Cl 0.2 g L⁻¹ and NaNO₃ 0.1 g L⁻¹).

As shown in Table 1, ten different combinations of experiments were developed. In particular:

i) the control (referred to as “K1”) made using seawater with the addition of crude oil (OIL);

ii) seawater, crude oil (OIL), and sepiolite (O+S);

iii) seawater+OIL+0.1 g sepiolite C16 (“O+S.C16.”);

iv) seawater+OIL+0.1 g sepiolite GPTMS (“O+S.G.”);

v) seawater+OIL+0.1 g sepiolite GPTMS C16 (“O+S.G.C16”);

vi) a second control (referred to as “K2”) made using seawater, with the addition of crude oil and ONR7a;

vii) seawater+ONR7a+OIL+0.1 g sepiolite (“M+O+S”);

viii) seawater+ONR7a+OIL+0.1 g sepiolite C16 (“M+O+S.C16);

ix) seawater+ONR7a+OIL+0.1 g sepiolite GPTMS (“M+O+S.G.”); and

x) seawater+ONR7a+OIL+0.1 g sepiolite GPTMS-C16 (“M+O+S.G.C16”).

Untreated microcosms (sterile seawater) were used in each series of experiments as a negative (abiotic) control.

At the beginning of the experiments (T0), 0.1% crude oil (Arabian Light Crude Oil; ENI Technology S.p.A.) was added to the SW and SW+IN microcosms. The crude oil was added to the microcosm systems after physical treatments (100 rpm, 25° C. for 48 h); the crude oil was added with 0.1% (v/v) squalene (C₃₀H₅₀, Sigma-Aldrich, Milan) as an internal reference for measuring the rate of bio-degradation.

TABLE 1
Set-up of the experiments developed during the study. Key: *M, ONR7a; O,
Crude oil; S, Sepiolite; S._{C16}, Sepiolite with C₁₆;S._{G}., Sepiolite with GPTMS;
S._{G.C16}, Sepiolite with GPTMS-C₁₆.

| | | | | | | SEP- | SEP- | |
|---|---|---|---|---|---|---|---|---|
| Experiment | SW | ONR7a | Oil | SEP. | SEP._{c16} | GPTMS | GPTMS-C16 | Code* |
| 1 | X | | X | | | | | K1 |
| 2 | X | | X | X | | | | O ← S |
| 3 | X | | X | | X | | | O ← S._{C16} |
| 4 | X | | X | | | X | | O ← S._{O} |
| 5 | X | | X | | | | X | O ← S._{O.C.16} |
| 6 | X | X | X | | | | | K2 |
| 7 | X | X | X | X | | | | M + O ← S |
| 8 | X | X | X | | X | | | M + O ← S._{C16} |
| 9 | X | X | X | | | X | | M + O ← S._{O}. |
| 10 | X | X | X | | | | X | M + O ← S._{O.C.16} |

Sampling strategy and parameters analyzed. Subsamples of each bacterial culture were collected aseptically at the beginning (T₀) and at the end (T₇) of the experimental period. Direct bacterial count measurements (DAPI) and oil degradation measurements (GC-FID analysis) were carried out. All the experiments were conducted twice and all the parameters were measured three times.

Total bacterial abundance (DAPI count). DAPI staining (4,6-diamidino-2-phenylindole 2HCl, Sigma-Aldrich, Milan, Italy) on formaldehyde-fixed specimens (2% final concentration), according to Porter and Feig (1980). The slides were examined by epifluorescence microscopy with an Axioplan 2 Imaging microscope (Zeiss) (Carl Zeiss, Thornwood, N.Y., USA) as stated in Cappello et al., (2007). The results were expressed as number of cells ml⁻¹.

Hydrocarbon analysis. The composition of the total extracted and resolved hydrocarbons (TERHCs) and the derivatives thereof were analyzed using a high resolution GC-FID (DANI Master GC Fast Gas Chromatograph System, DANI Instruments S.p.A., Milan). After seven days, the TERHCs of different samples were extracted using dichloromethane (CH₂Cl₂, Sigma-Aldrich, Milan; 10% v/v). This procedure was repeated three times, and the CH₂Cl₂ phase was treated with anhydrous sodium sulphate (Na₂SO₄, Sigma-Aldrich, Milan) to remove water residues (Ehrhardt et al., 1991; Wang et al., 1998; Dutta and Harayama 2001; Denaro et al., 2005). The extracts were concentrated to 1 ml by rotavapor (Rotavapor model R110; BiichiLabortechnik AG, Switzerland) at room temperature (<30° C.). All measurements were performed using a DANI Master GC instrument (Development Analytical Instruments), equipped with an SSL injector and FID. Samples (1 μl) were injected in splitless mode at 330° C. The analytical column was a Restek Rxi-5 Sil MS with Integra-Guard, 30 m×0.25 mm (ID×0.25 lm film thickness). The carrier gas, helium, was maintained at a constant flow of 1.5 ml min⁻¹. The total hydrocarbons were also calculated for each sample (Genovese et al., 2014). The ratios selected for this study were: n-C17/Pristane (nC17/Pr), n-C18/Phytane (nC18/Ph) to assess the relative biodegradation of n-alkanes.

TERHC biodegradation efficiency (BE). TERHC degradation was expressed as the percentage of degraded TERHCs in relation to the amount of the remaining fractions in the appropriate control samples. The biodegradation efficiency (BE), based on the decrease in the total hydrocarbon concentration, was calculated using the expression described by Michaud et al., 2004: 100−(As*100/Aac) where As=total area of the peaks in each sample, Aac=total area of the peaks in the appropriate abiotic control, and BE (%)=Biodegradation Efficiency.

### Chemical Functionalization of Sepiolite

Different preparations were used for sepiolite sol-gels, as stated below:

(a) Aqueous solution procedure: 200 mg sepiolite was dissolved in 200 ml aqueous solution, vigorous stirring was started, then 7 g 97% GPTMS was injected, and a 50 mL aqueous solution was prepared with 0.35 g BF₃, which was added at a rate of 10 mL every 30 minutes. The total reaction time starting from the first addition of BF₃ was approximately 24 h, at the end of which the pH of the solution was checked and brought to above 5 with a small amount of 0.1M NaOH. The solution was then filtered with a Millipore filter to separate it from the undissolved part.

(b) Ethanolic solution procedure: 200 mg sepiolite was dissolved in 200 mL ethanolic solution, under stirring at 70° C. in a continuous reflux setup. Immediately afterwards, 7 g 97% GPTMS and 2 mL 0.1 M HCl were added as a catalyst. The total reaction time starting from the addition of HC1 was approximately 24 h, at the end of which the pH of the solution was checked and brought to above 5 with a small amount of 0.1M NaOH. The solution was then filtered with a Millipore filter to separate it from the undissolved part and applied.

c) Procedure with various solvents: with KOH (2 tablets), in 50 mL of alcoholic solvents, organic solvents (toluene, THF) or halogenated solvents, in reflux set-up overnight.

d) Procedure with various solvents with GPTMS and C16: 3 g sepiolite was reacted with 3 mL GPTMS (or C16) with KOH (2 tablets), in 50 mL alcoholic solvents, organic solvents (toluene, THF) or halogenated solvents, in a reflux set-up overnight.

### Functionalization of Fabrics and Other Surfaces

The hybrid sols thus obtained in water and ethanol containing GPTMS/C16 and the appropriate nanofillers (sepiolite) were applied to cotton (C) and polyester (PE) cloths. After the preparation of the sols, the next step was the impregnation on fabric. The cotton (C) and polyester (PE) cloths (20×30 cm²) were impregnated with the hybrid sol and then passed through a two-roller laboratory applicator (Werner Mathis, Zurich, Switzerland), operating at a pressure of 3 bar in order to obtain up to 70% water removal. After drying at 80° C. for 5 min, the fabrics were heat treated at 170° C. (C) and 215° C. (PE) for 4 min in a convection stove. At the end, the fabrics were washed repeatedly (1 wt % detergent, 1 and 5 wash cycles) to test the washing resistance of the fabric coating and to remove excess dye, if present, and then dried and stored in standard conditions in an environmental chamber. For comparison purposes, the corresponding fabrics were prepared by applying the sol without dye. All samples were characterized by UV-Vis reflectance measurements and by FT-IR spectroscopy. The weight of each fabric before and after impregnation was recorded, to assess the difference in weight in grams and as a percentage (Add-on). The fabrics were tested with an anti-flame test that revealed a reasonable resistance to burning.

Functionalization of the fabrics takes place through the coupling of the epoxide of the GPTMS nanofiller on the structure of the fabrics. In the case of cotton, the —OH groups of glucose, a constituent molecule of cellulose fibres, are coupled by the epoxide of the GPTMS. This whole process takes place during the polymerization of the GPTMS with immobilization of the nano-structures inside.

As a synthetic fabric, polyethylene terephthalate (PET) was used.

TABLE 2
Table summarizing the experimental conditions
(weight, solvent, volumes) of certain syntheses
of sols containing the appropriate nanofillers (NF).

| | | | | | GPTMS: |
|---|---|---|---|---|---|
| Sample^{a} | NF/g | V_{Tot}/mL | GPTMS/g | Catalyst^{a} | NF ratio |
| 1SA | 1.013 | 100 | 7 | 0.35 | 7:1 |
| 2SA | 0.200 | 100 | 7 | 0.35 | 35:1 |
| 3SA | 0.200 | 200 | 7 | 0.35 | 35:1 |
| 4SA | 0.208 | 200 | 7 | 0.21 | 34:1 |
| 5SA | 0.106 | 100 | 7 | 0 | 66:1 |
| ISEt | 1.014 | 100 | 7 | 2 | 7:1 |
| 2SEt | 0.200 | 100 | 7 | 2 | 35:1 |
| 3SEt | 0.201 | 200 | 7 | 2 | 35:1 |

^{a}A = Reaction in water at room temperature with BF3 as catalyst (in g); Et = Reaction in Ethanol at 70° C. with HCl as catalyst (in mL); S = Sepiolite; with KOH as catalyst.

TABLE 3
Table summarizing the treated fabrics (weight, solution, loss after washing)
after deposition of the Sepiolite sol-gels (S).

| Sol-Gel | | | Loss | Loss |
|---|---|---|---|---|
| fabric | Add-on (g) | Add-on (%) | wash 1 (%) | wash 5 (%) |
| t1T2c-ISA | 0.7437 | 4.54 | 0.45 | 0.28 |
| t2T3c-2SA | 0.6102 | 5.30 | 3.09 | 2.69 |
| t2T3pe-2SA | 0.5103 | 4.92 | 0.58 | 0.48 |
| t3T1c-4SA | 0.3361 | 2.05 | 2.21 | 1.32 |
| t3T1pe-4SA | 0.1032 | 1.51 | 0.05 | 0.03 |
| t1T4c-1SEt | 1.1926 | 7.11 | 1.98 | 1.48 |
| t2T4c-2SEt | 0.6628 | 5.64 | 4.88 | 3.39 |
| t2T4pe-2SEt | 0.3819 | 3.98 | 2.56 | 2.71 |
| t3T2c-3SEt | 0.4214 | 2.68 | 2.59 | 2.58 |
| t3T2pe-3SEt | 0.0886 | 1.27 | 0.05 | 0.12 |

A = Reaction in water at room temperature with BF3 as catalyst (in g); Et = Reaction in Ethanol at 70° C. with HCl as catalyst (in mL); S = Sepiolite; C = Cotton; PE = Polyester

Sepiolite sol was applied to the following fabrics: Cotton, 4SA; Polyester, 4SA; Cotton, 3Set; Polyester, 3Set.

TABLE 4
Table showing the results of the flame-retardant tests on Cotton (C) samples
with Sepiolite sol applied.^{a}

| | | Unwashed | | Flame | | Flame | |
|---|---|---|---|---|---|---|---|
| | Unwashed | flame | Flame | residue, | Flame | residue, | Original |
| Sol-Gel | flame | residue | residue, | wash 1 | residue, | wash 5 | add-on |
| fabric | residue (g) | (%) | wash 1 (g) | (%) | wash 5 (g) | (%) | (%) |
| t1T2c-1SA | 0.0241 | 4.89 | 0.0145 | 3.30 | 0.0149 | 3.11 | 4.54 |
| t1T4c-1SEt | 0.0179 | 4.08 | 0.0147 | 3.22 | 0.0129 | 2.85 | 7.11 |

^{a}A = Reaction in water at room temperature with BF³ as catalyst (in g); Et = Reaction in Ethanol at 70° C. with HCl as catalyst (in mL); S = Sepiolite; C = Cotton; PE = Polyester.

### Structural Analysis by SEM/EDX Microscopy

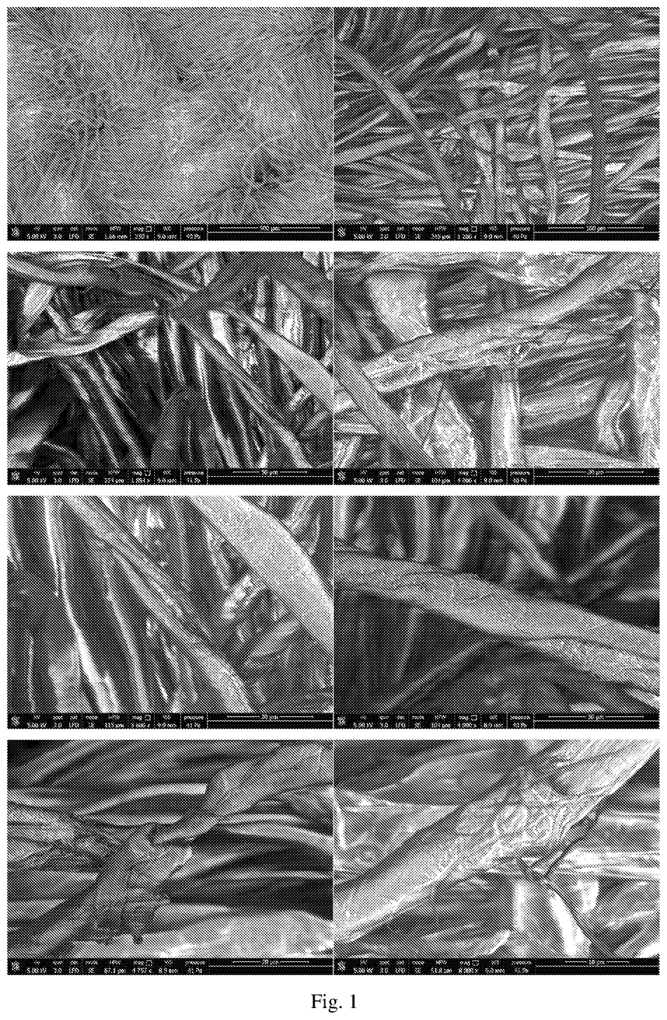

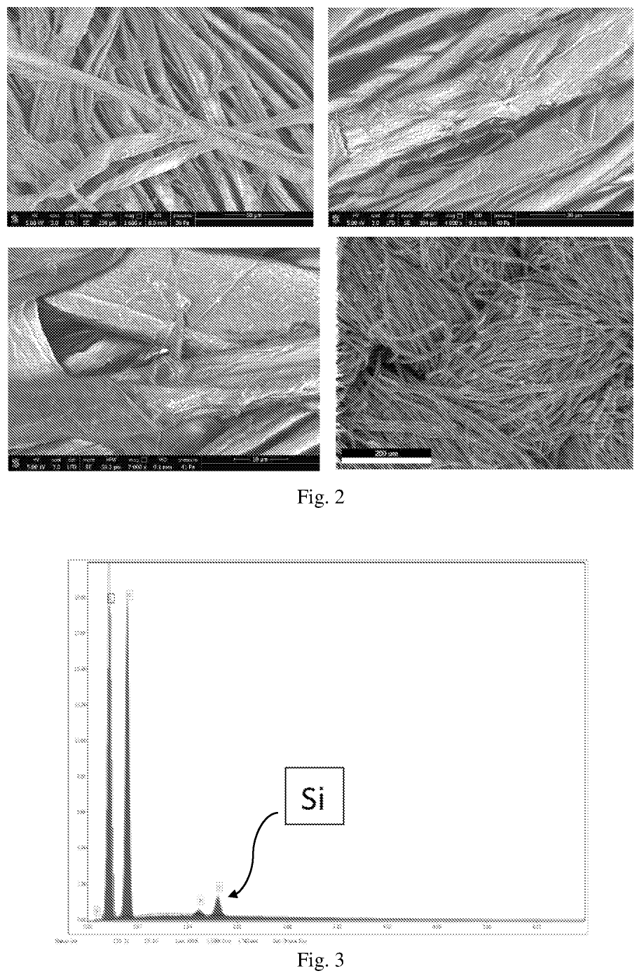

SEM images and SEM-EDX mapping of treated and unanalyzed cotton samples were obtained with an SEM FEI Quanta FEG 450 microscope. The treated and then washed cotton samples, compared to untreated cotton (shown in FIG. 1), show the presence of GPTMS, as is clear in FIG. 2 The fibres appear to be glued together by the salicaceous matrix, while in the sample of untreated cotton, the fibres are well separated.

The EDX analysis in FIG. 3 shows the presence of the aforesaid matrix in the treated samples only. The other peaks refer to C (present in the graphitic adhesive and in the fabric), to oxygen (also present in the high-vacuum steam atmosphere), and aluminium from the SEM support. This shows that following treatment with GPTMS-based sols, there was a change in the fibres on a micrometric scale.

### Characterization by IR spectrophotometry

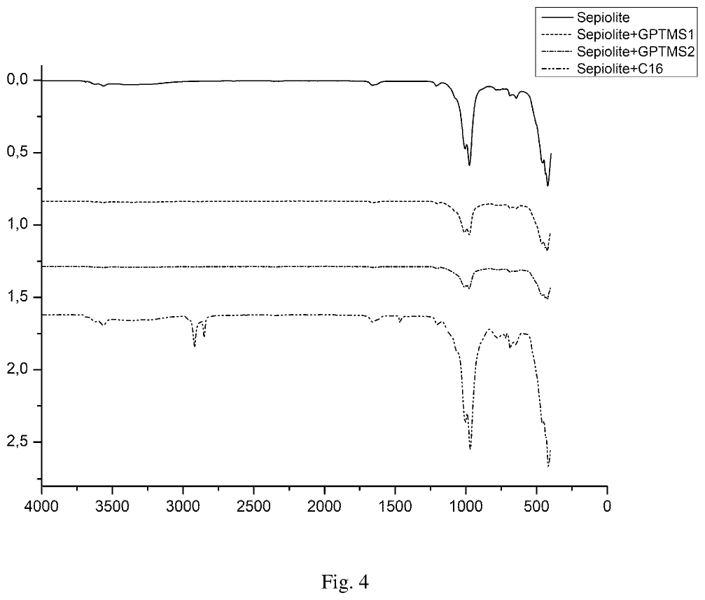

FIG. 4 shows the comparison between the IR spectra of Sepiolite and of the Sepiolite functionalized through various procedures.

Stretching at 2917 cm⁻¹, 2850 cm⁻¹, 1468 cm⁻¹, relating to the —CH₃ and —CH₂— groups confirm the functionalization of the sepiolite. —OH stretching can be seen at 1657 cm-¹. At 1205 cm-¹ are the lattice vibrations, in accordance with the high Si/Mg ratio of the reagent solution.

### Results

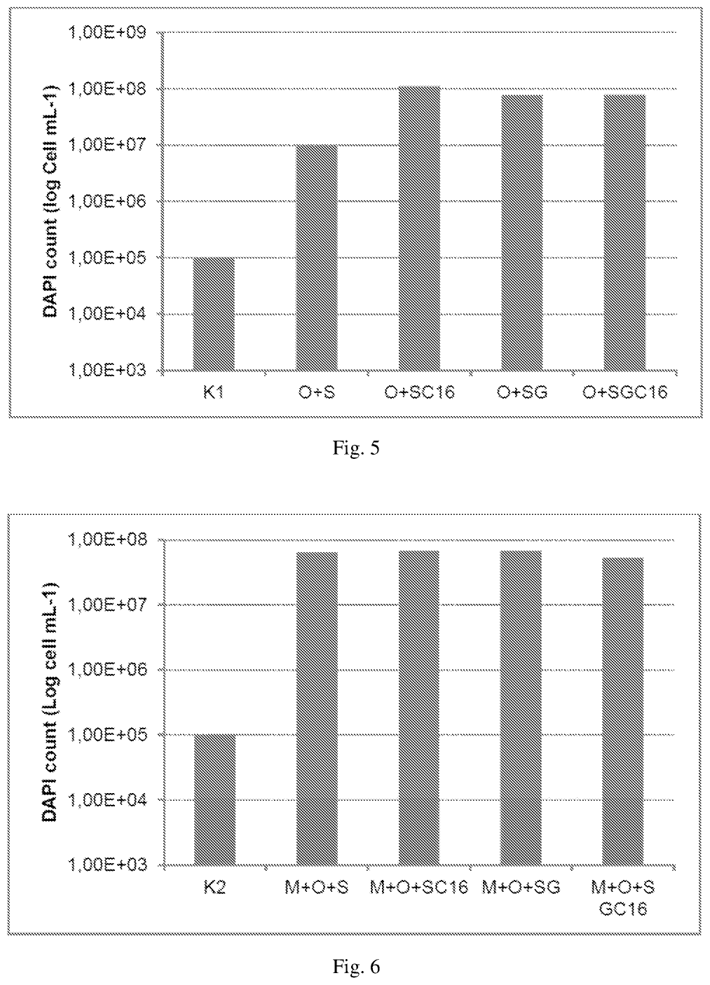

FIGS. 5 and 6 show the bacterial abundance (DAPI count) of the microbial population developed during the experimentation carried out with, respectively, said natural seawater (SW) and ONR7 inorganic nutrients.

In FIG. 5, a high bacterial abundance can be noted for the O+S_{C16} samples, which contain seawater, oil, and C₁₆, with a cell count of approximately 1.12×10⁸cell mL⁻¹. Good bacterial growth was also shown by the Sepiolite GPTMS and GPTMS C₁₆ samples.

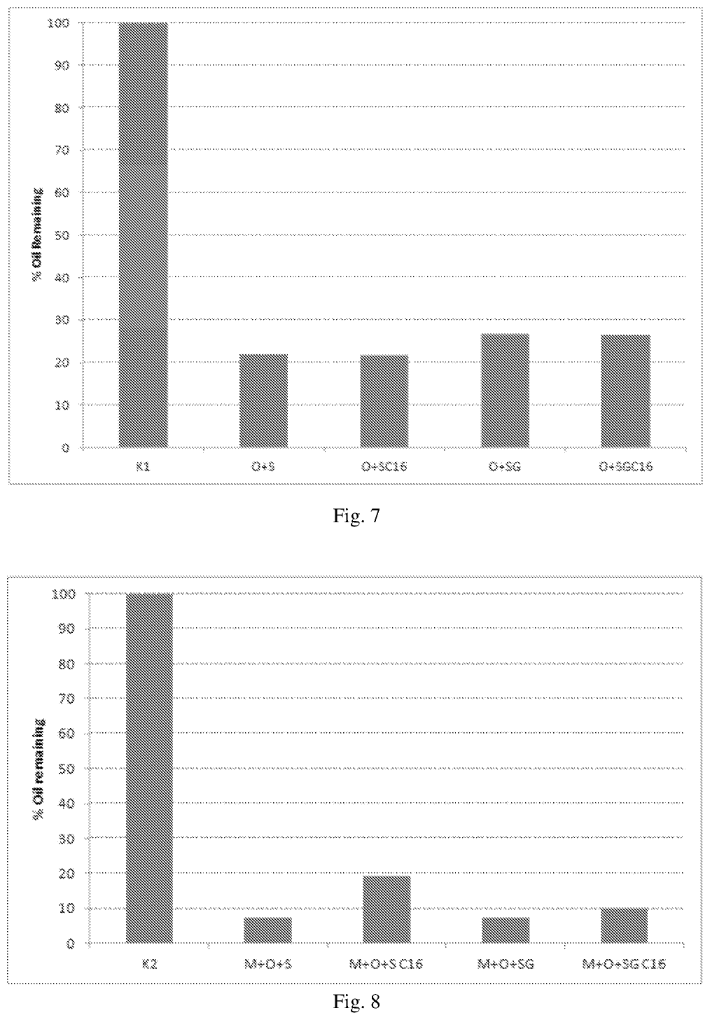

FIG. 7 shows the percentage of oil obtained from the GC-FID analysis after an experimental period of seven days.

The lowest percentage refers to the O+S_{C16} sample (approximately 21%), while the slightly higher values refer to O+S, O+S_{G} and O+S_{GC16} (22%, 28%, and 26%, respectively).

In FIG. 8, ONR7a inorganic nutrients were added to the samples.

The lowest percentage of residual oil was found in the M+O+S and M+O+S_{G} samples (approximately 7% and 8%, respectively), while the highest values were found in the M+O+S_{C16} and M+O+S_{GC16} samples (approximately 19% and 10%, respectively).

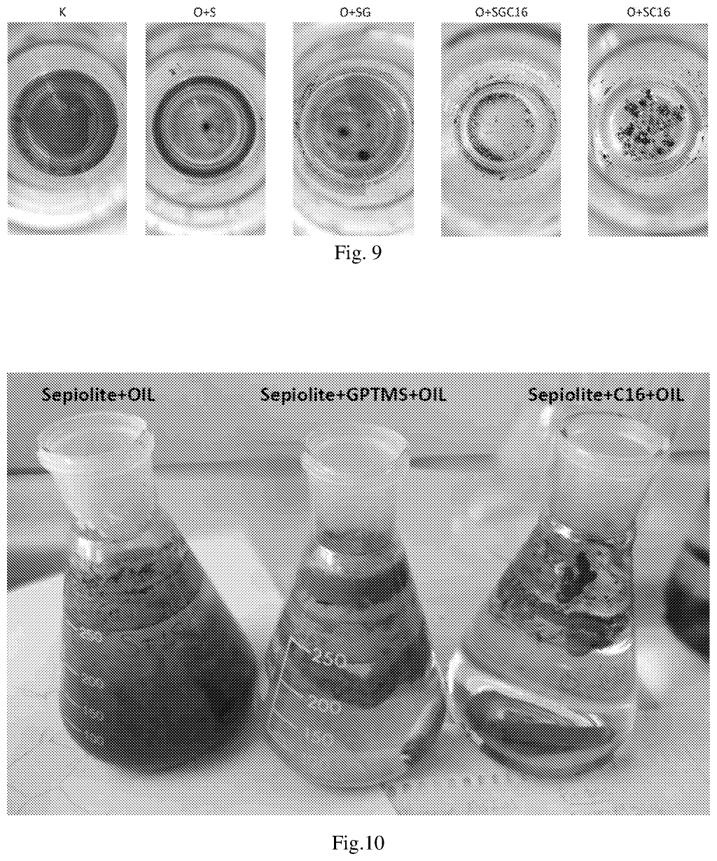

FIG. 9 shows, visually, the oil absorption by the various samples analyzed. Visually, the O+S_{C16} sample gives the best results as regards oil absorption (the absorption for spent and non-spent oils was also tested) and material buoyancy. The sample O+S_{GC16} also shows a remarkable absorption, but the floating material is not agglomerated, but rather distributed over the surface of the water.

1. A functionalized hybrid material comprising a sepiolite functionalized with at least an alkoxysilane crosslinking agent, wherein said at least an alkoxysilane crosslinking agent comprises an epoxy trialkoxysilane.

2. The functionalized hybrid material of claim 1, wherein said at least an alkoxysilane crosslinking agent and said sepiolite are in a weight ratio of 1:5 to 5:1.

3. The functionalized hybrid material of claim 2, wherein said at least an alkoxysilane crosslinking agent and said sepiolite are in a weight ratio of 1:2 to 2:1.

4. The functionalized hybrid material of claim 3, wherein said epoxy trialkoxysilane is 3-glycidoxypropyltrimethoxysilane.

5. The functionalized hybrid material of claim 1, wherein said at least an alkoxysilane crosslinking agent is an aliphatic trialkoxysilane having formula (I): 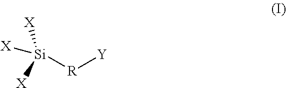
where X is an alkoxy group, R is a C4-C20 aliphatic chain, and Y is a methyl, amino, or thiolic group.

6. The functionalized hybrid material of claim 5, comprising a sepiolite functionalized with a mixture of a) at least an epoxy trialkoxysilane and b) at least an aliphatic trialkoxysilane having formula (I), wherein a) and b) are in weight ratio of 5:1 to 1:5.

7. The functionalized hybrid material of claim 6, comprising a sepiolite functionalized with a mixture of 3-glycidoxy propyltrimethoxysilane and hexadecyltrimethoxysilane.

8. The functionalized hybrid material of claim 7, wherein 3-glycidoxy propyltrimethoxysilane and hexadecyltrimethoxysilane are in weight ratio of 2:1 to 1:2.

9. A method of absorbing and degrading substrate of hydrocarbon pollutant with of the functionalized hybrid material of claim 1, said method comprising
activating hydrocarbonoclastic bacteria with said functionalized hybrid material, and
obtaining environmental recovery and restoration.

10. Product for the recovery and environmental remediation, comprising the functionalized hybrid material of claim 1, said product being a fabric, a sponge or a polymeric foam.

11. The functionalized hybrid material of claim 1, wherein said at least an alkoxysilane crosslinking agent is hexadecyltrimethoxysilane.
